(19) United States
(12) Patent Application Publication
(10) Pub. No.: US 2026/0040085 A1
(43) Pub. Date: Feb. 5, 2026

(54) DSRC Toll System Interference Mitigation Solution based on GPS Information

(71) Applicant: Cypress Semiconductor Corporation, San Jose, CA (US)

(72) Inventors: Young San Kim, Deogyang-gu (KR); Jeong Won Woo, Gunpo-si (KR); Hyun Jong Lee, Seoul (KR)

(73) Assignee: Cypress Semiconductor Corporation, San Jose, CA (US)

(21) Appl. No.: 18/794,329

(22) Filed: Aug. 5, 2024

(51) Int. Cl. H04W 16/14; H04W 64/00; H04W 84/12

(52) U.S. Cl. CPC H04W 16/14; H04W 64/00; H04W 84/12

(57) ABSTRACT

Disclosed are methods and systems for a WLAN device to select an operating dynamic bandwidth selection (DBS) channel that minimizes the probability of interference from a dedicated short range communication (DSRC) device by using positional information. The WLAN device may operate on a first DBS channel of a plurality of DBS channels within a first bandwidth. The WLAN device may determine that the WLAN device is approaching a geo-tagged zone, where the geo-tagged zone interferes with operation of the WLAN device. The WLAN device may change the operation of the WLAN device from the first DBS channel to a second DBS channel within a second bandwidth in response to determining that the WLAN device is approaching the geo-tagged zone.

### TECHNICAL FIELD

The subject technology generally relates to wireless local area network (WLAN) systems, and more particularly, to systems and methods for devices or vehicles that operate in WLAN dynamic bandwidth selection (DBS) channels to minimize interference to co-existing dedicated short range communication (DSRC) systems.

### BACKGROUND

WLAN systems complying with the IEEE 802.11 standard may operate in the 2.4 GHz, 5 GHz, or higher frequency bands. Channels in the 5 GHz band are classified based on their allowed usage as indoor or outdoor channels. WLAN outdoor channels in the 5 GHz band are increasingly being used in automobiles for in-vehicle networking as well as in automobiles to exchange information with each other and to receive information from system infrastructure to aid autonomous driving and other applications. There are several automated wireless toll road collection systems that utilize 5.8 GHz dedicated short range communication (DSRC) radio frequency to communicate between a vehicle 101 equipped with a WLAN device 102 and the toll road collection system 103, as shown for example in diagram 100 of FIG. 1. The toll road collection system 103 may include DSRC antennas 104 for each lane of traffic where each DSRC antenna 104 communicates with each vehicle 101 via a respective beam 105 as each vehicle 101 passes under or by the toll road collection system 103.

These toll road collection systems may operate at a very high transmit power and the frequency may overlap with an upper half of the highest 80 MHz Wi-Fi channel in 5 GHz unlicensed national information infrastructure (U-NII) band (e.g., U-NII-3 band), which may result in completely jamming the in-car Wi-Fi and freezing Wi-Fi projection applications (e.g., Apple CarPlay®, Android Auto®) as the car passes under or along the toll booth. For example, with reference to diagram 200 of FIG. 2A and diagram 210 of FIG. 2B, DSRC frequency bands and center frequencies allocated for DSRC are within the range of 5.795 GHz-5.815 GHz, which overlaps, at 201, the only 80 MHz channel in U-NII-3 band (e.g., Ch 155) which renders the only 80 MHz channel in U-NII-3 band completely inoperable.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an example outdoor wireless local area network (WLAN) architecture deployed for automobiles, in accordance with some embodiments of the present disclosure.

FIG. 2A illustrates an example diagram of dynamic bandwidth selection (DBS) channels available for use by the WLAN device, in accordance with some embodiments of the present disclosure.

FIG. 2B illustrates an example diagram of dedicated short range communication (DSRC) frequencies used in different DSRC systems, in accordance with some embodiments of the present disclosure.

FIG. 3 illustrates an example diagram of conditions for detection of availability of a medium, in accordance with some embodiments of the present disclosure.

FIG. 4 illustrates an example of an operating mode notification (OMN) action frame, in accordance with some embodiments of the present disclosure.

FIG. 5 illustrates an example diagram of throughput of the DBS channel within a second bandwidth, in accordance with some embodiments of the present disclosure.

FIG. 6 illustrates an example diagram of operational bandwidth changes of the WLAN device in relation to the DSRC system, in accordance with some embodiments of the present disclosure.

FIG. 7 illustrates a flow diagram of a method for a WLAN device deployed in an automobile to change operational bandwidths of the WLAN device based on a known geo-tagged zone, in accordance with some embodiments of the present disclosure.

FIG. 8 is a block diagram of a WLAN device deployed in an automobile configured to change operational bandwidths of the WLAN device based on a known geo-tagged zone, in accordance with some embodiments of the present disclosure.

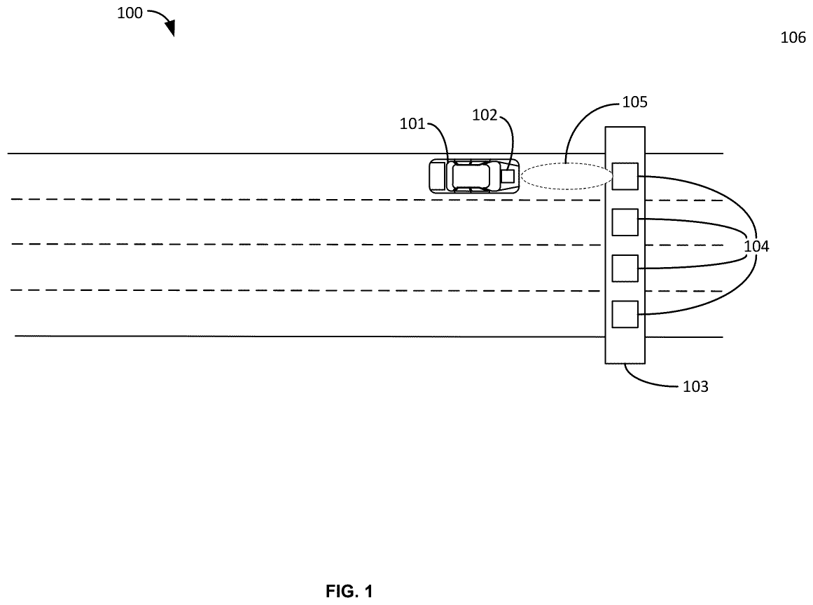

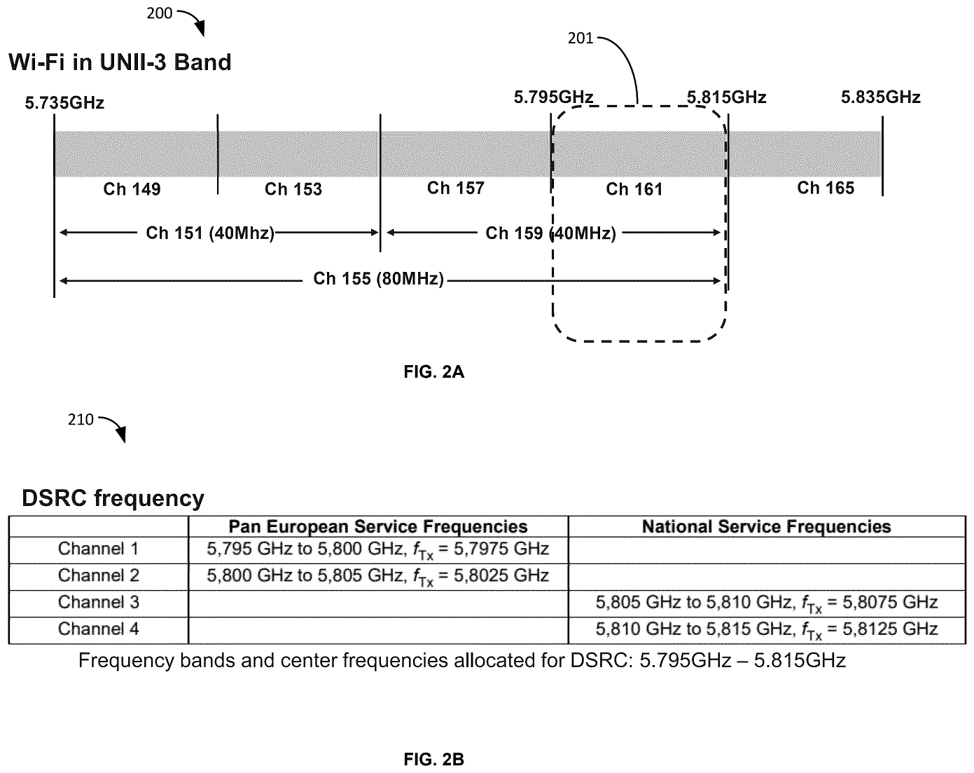

### DETAILED DESCRIPTION

Examples of various aspects and variations of the subject technology are described herein and illustrated in the accompanying drawings. The following description is not intended to limit the invention to these embodiments, but rather to enable a person skilled in the art to make and use this invention.

In one aspect of the subject technology, a wireless local area network (WLAN) device may be deployed in an automobile and configured to operate the WLAN device on a first dynamic bandwidth selection (DBS) channel that is within a first bandwidth. The WLAN device may switch from the first DBS channel within the first bandwidth to a second DBS channel within a second bandwidth upon detection of interference from a dedicated short range communication (DSRC) system. The detection of interference from the DSRC system may be determined based on the WLAN device approaching a known positional location of the DSRC system. The WLAN device may resume operation of the WLAN device on a DBS channel within the first bandwidth upon departure of the known positional location of the DSRC system.

In one embodiment, a database of known positional locations of DSRC systems may be stored locally in the WLAN device or the automobile or may be located at a centralized server. The WLAN device may store positional information on detected DSRC systems over time into the local database. The WLAN device may query the local database as the automobile approaches a DSRC system to switch to a DBS channel within a different bandwidth than that of the DSRC system which is a source of interference for the WLAN device.

In some aspects, the WLAN device may be configured to automatically and autonomously switch bandwidths from a first bandwidth (e.g., 80 MHz) to a second bandwidth (e.g., 40 MHz) upon detection of interference from a DSRC (e.g., toll road collection system), where the WLAN device utilizes the first bandwidth while not in the vicinity of DSRC systems and uses the second bandwidth in the vicinity of DSRC systems. The detection of the interference of the DSRC system (e.g., toll road collection system) may be based on the known positioning of the DSRC system within a database of known DSRC systems. For example, the WLAN device may become aware of the WLAN device approaching a DSRC system within the database of known DSRC systems based on the positioning of the WLAN device.

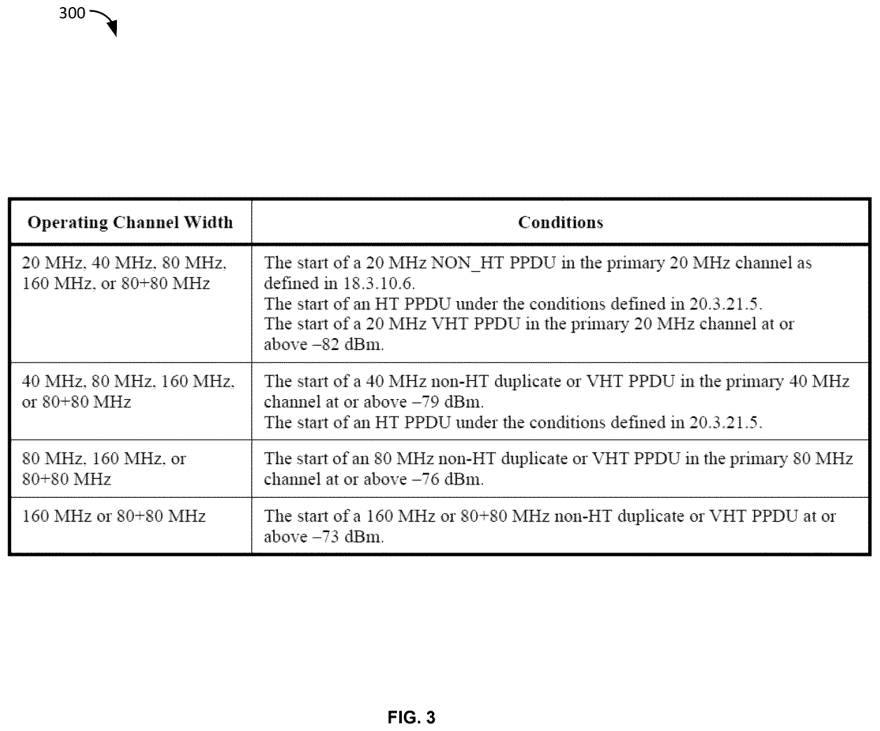

In dynamic bandwidth selection (DBS), a clear channel assessment (CCA) may detect whether a medium is in a busy condition when the carrier sense (CS)/CCA (CS/CCA) mechanism or CCA-energy detect (CCA-ED) detects a channel busy condition. For example, diagram 300 of FIG. 3 shows conditions (e.g., received signal strength indicator (RSSI)) for CCA busy on a primary 20 MHz, 40 MHz, 80 MHz, 160 MHz, or 80+80 MHz operating channel bandwidth. An operating mode notification (OMN) action frame may also be utilized along with the DBS configuration to mitigate interference. OMN action frame is a type of management frame subtype used for spectrum management, fast basic service set (BSS) transition, and other actions of a BSS. In some instances, either an access point (AP) or a station (STA) can initiate a dynamic bandwidth switch that may lead to a channel/bandwidth switch for the entire BSS.

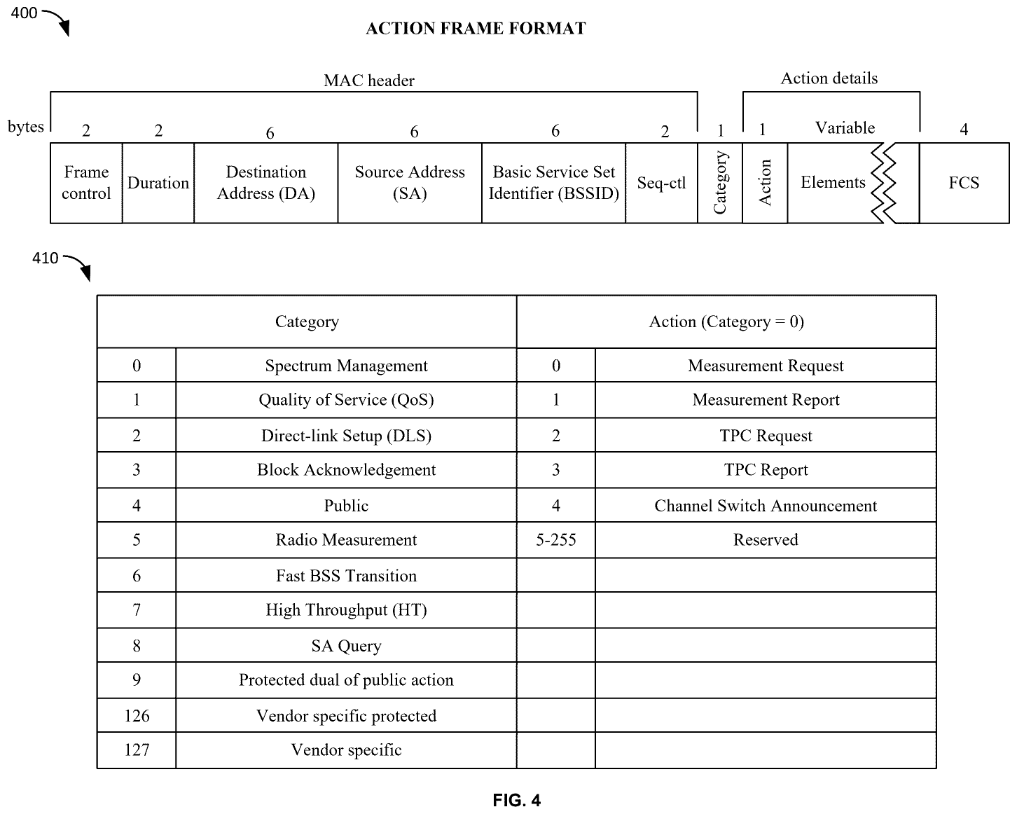

FIG. 4 is a diagram 400 of an action frame format. The action frame format includes a media access control (MAC) header and action details. The MAC header includes frame control, duration, destination address, source address, basic service set identifier, and sequence control. The action details include an action field and elements. The frame control may determine the interpretation of the rest of the fields in the frame. The duration includes information related to the expected duration of a transmission. The destination address includes information related to the destination of the transmission. The source address includes information related to the source of the transmission. The basic service set identifier includes information related to a unique identifier for a specific access point within a wireless network. The sequence control identifies and manages the transmission sequence of frames. The action field relates to an action to perform. The elements field is a variable length field that includes information related to individual frame types and subtypes. The action frame format also includes a category field and a frame check sequence (FCS). The category field describes the action frame type. The FCS is used by a receiver to confirm that the MAC header and action details are properly received.

The table 410 lists values of the category field that may be utilized and the corresponding action details. The action details may include at least spectrum management, quality of service (QoS), direct-link setup (DLS), block acknowledgment, public, radio measurement, fast basic service set transition, high throughput, source address query, or protected dual of public action, while some category values (e.g., 126, 127) are reserved vendor specific protected or vendor specific. In some instances, such as when the category value is 0, the value of the action field may indicate an action to be performed. For example, the actions may include measurement request, measurement report, transmit power control (TPC) request, TPC report, channel switch announcement, while some action values (e.g., 5-255) are reserved for future use.

In some aspects, the WLAN device may use the action frame to change the channel bandwidth during Wi-Fi communication. The action frame may be utilized to trigger or to notify the change of the channel bandwidth. For example, the WLAN device may indicate in the Category code of 0 referring to Spectrum Management and an Action code of 4 referring to Channel Switch Announcement in order to change the bandwidth in response to detected interference.

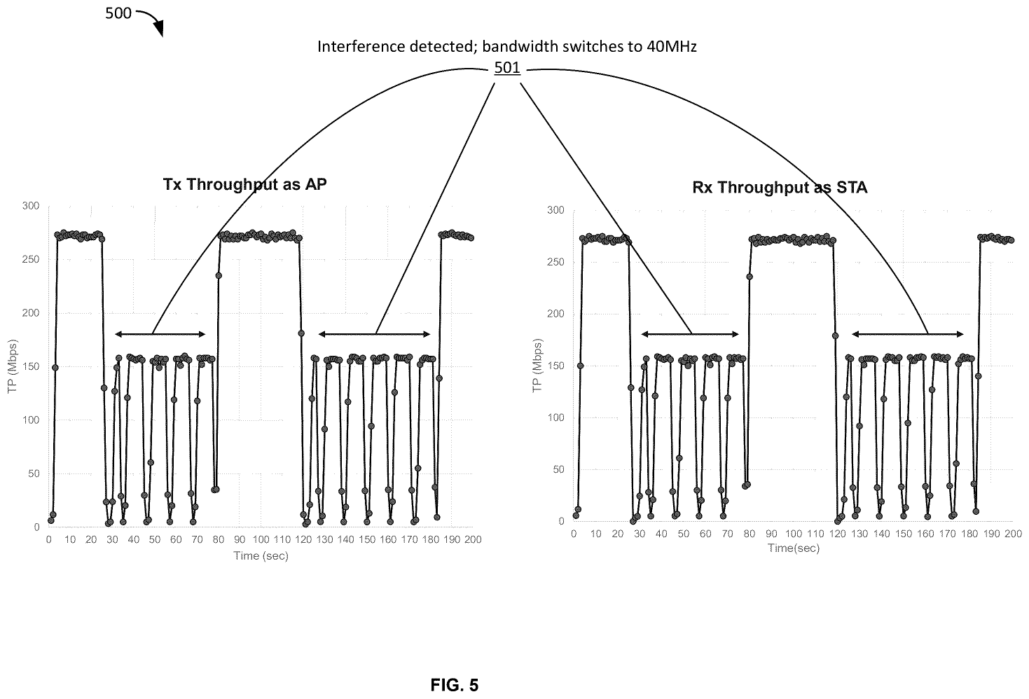

FIG. 5 is a diagram 500 of an example throughput of the DBS channel within the second bandwidth. In some instances, in response to interference 501 within the first bandwidth, the WLAN device may switch to a second bandwidth, where the second bandwidth is less than the first bandwidth. The throughput of the WLAN device while operating in the second bandwidth may be less than the throughput of the WLAN device while operating in the first bandwidth. However, the decline or reduction of throughput may be within tolerances and may not cause with packet delays or result in any voice/data dropping issues. As such, the switching to the second bandwidth provides an interference mitigation solution while without degrading the quality of service. For example, remaining in an 80 MHz bandwidth may result in a complete loss of function due in part to the interference. Although the switch to the lower bandwidth may result in a reduction in throughput, but from a user perspective, such reduction in throughput is preferred over zero throughput or complete loss of function.

Interference mitigation from DSRC systems can be difficult due to WLAN devices having different RF performance due to different hardware design and antenna performance. The ability to efficiently detect interference while traversing toll road collection systems or DSRC systems can be difficult. Aspects presented herein are directed to systems and methods for devices or vehicles that operate in WLAN DBS channels to minimize interference from DSRC systems. For example, WLAN devices may be configured to switch from a first bandwidth to a second bandwidth as the WLAN device is approaching a DSRC system, such that the DSRC system does not interfere with the second bandwidth. The WLAN device may resume utilizing a channel within the first bandwidth once the WLAN device has departed from the DSRC system.

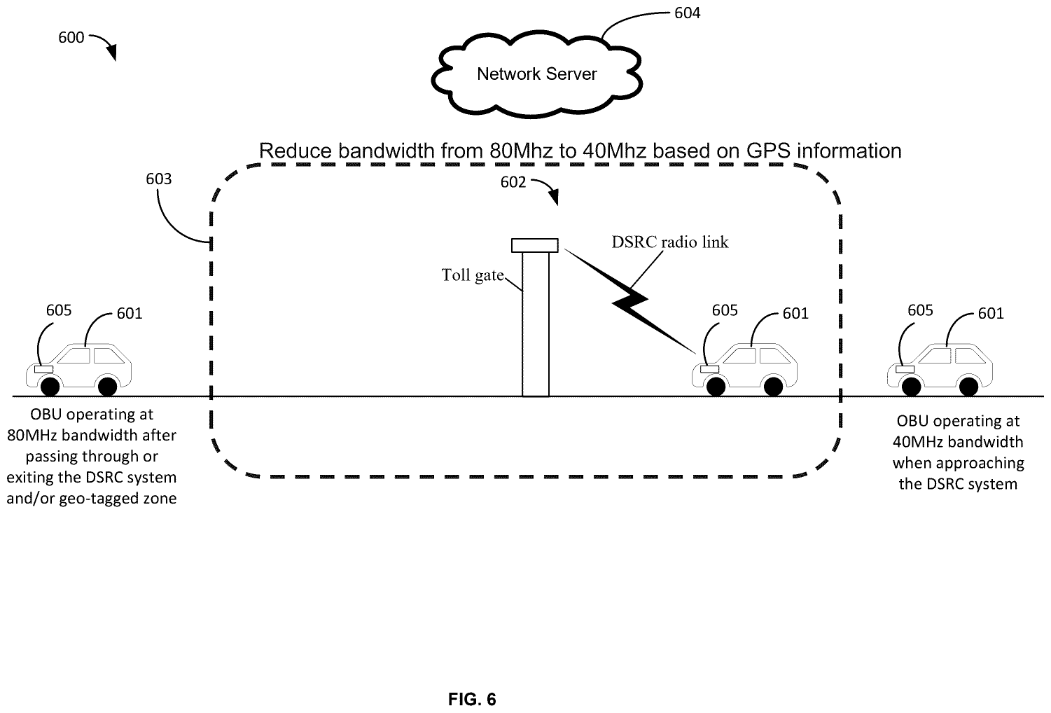

FIG. 6 illustrates an example of communications between a vehicle and a DSRC system. The vehicle 601 may comprise wireless local area network (WLAN) architecture deployed for automobiles (e.g., on-board unit 605), in accordance with some embodiments of the present disclosure. WLAN devices may be deployed in automobile 601 to communicate using an applicable IEEE 802.11 standard, for example IEEE 802.11ax or IEEE 802.11be. The WLAN devices may be user stations (STAs) configured to associate with an access point (AP) deployed adjacent to the road when automobiles come within a range of the AP. The WLAN devices in automobile 601 and the AP may form a BSS. Once associated with the AP, the WLAN device may receive information such as road condition, traffic condition, environmental and other infrastructure information from the AP to assist the vehicle 601 in navigating the road. In one scenario, the automobiles equipped with WLAN devices may exchange vehicle information such as speed, heading, etc., in peer-to-peer communication with another automobile using the WLAN devices without routing the data traffic through the AP. In one scenario, the vehicle 601 may host a SoftAP or a Peer-to-Peer Group Owner (P2P GO) to which in-vehicle WLAN clients (e.g., mobile phones with WLAN capability carried by passengers or in-vehicle entertainment consoles of passenger seats) inside the vehicle 601 may connect to, through which infotainment contents may be exchanged.

The WLAN system may operate on one or more 5 GHZ WLAN DBS channels. The WLAN device in vehicle 601 may be a WLAN DBS device configured to detect the presence of DSRC systems in an operating channel and may be configured to switch to a different channel within a different bandwidth to mitigate interference from the transmissions of the DSRC systems. DSRC systems may operate in a bandwidth that overlaps with one or more channels that may be utilized by the WLAN device. The vehicle 601 may detect the presence of DSRC systems (e.g., toll road collection systems) based on a known positional location of the DSRC system 602. For example, DSRC systems are static, and their locations may be entered into a database of DSRC systems. The databased may be stored within the vehicle 601, the WLAN device, or may be on a network server (604) that may be accessible by the vehicle 601 and/or the WLAN device. The locations of DSRC systems may be entered based on their GPS coordinates.

In some instances, the DSRC systems may be identified as being within a region or a geo-tagged zone 603. The geo-tagged zone 603 may include an area or region that extends beyond the precise location of the DSRC system 602 to define an area or region that provides a physical separation between the vehicle 601 and the DSRC system 602 to allow the vehicle to switch to a different bandwidth prior to entering or as the vehicle is approaching the geo-tagged zone 603. For example, the WLAN device of the vehicle 601 may operate on a channel in a first bandwidth (e.g., 80 MHz bandwidth) while the vehicle is outside the geo-tagged zone 603, and the vehicle and/or the WLAN device, may determine that as the vehicle is traversing the road, it is approaching the geo-tagged zone 603 such that the WLAN device may switch to a channel in a second bandwidth (e.g., 40 MHz bandwidth). The WLAN device may switch to the channel in the second bandwidth as it is approaching the DSRC system 602 within the geo-tagged zone 603. In some aspects, the switch to the channel in the second bandwidth may occur prior to entering the geo-tagged zone 603, as the vehicle 601 is entering the geo-tagged zone 603, or shortly after entering the geo-tagged zone 603. While the vehicle 601 is within the geo-tagged zone 603, the WLAN device operates on the channel in the second bandwidth. The channel in the second bandwidth is not overlapped by transmissions or a radio link from the DSRC system 602 and does not experience interference. The channel in the first bandwidth is overlapped by the transmissions or the radio link from the DSRC system 602 and would experience interference such that the WLAN device would be inoperable.

Once the vehicle 601 has passed through the DSRC system 602 and is departing from the geo-tagged zone 603, the WLAN device may switch back to a channel within the first bandwidth. For example, the WLAN device and/or the vehicle 601 may determine that the vehicle 601 is passing through or exiting the geo-tagged zone 603 such that the WLAN device may switch to a channel in the first bandwidth. The WLAN device and/or the vehicle 601 may determine that the vehicle is passing through or exiting the geo-tagged zone 603 based at least on the GPS coordinates of the vehicle 601 and/or the WLAN device with respect to the geo-tagged zone 603. In some aspects, the switch to the channel in the first bandwidth may occur prior to exiting the geo-tagged zone 603, as the vehicle 601 is exiting the geo-tagged zone 603, or shortly after exiting the geo-tagged zone 603.

Examples, implementations, and embodiments described herein are primarily described in the context of a WLAN. In one embodiment, the WLAN system may be a WLAN network using various versions of the IEEE 802.11 standard. However, other WLAN system or communication systems based on other wireless protocols may be contemplated.

In some aspects, vehicle 601 may periodically transmit its GPS coordinates to a network server 604. The GPS coordinates of the vehicle may include a predetermined path of travel or based on an expected path of travel, and the network server 604 may determine that the vehicle 601 will approach the geo-tagged zone 603 of the DSRC system 602. The network server 604 may provide an indication to the vehicle 601 that the vehicle is approaching the geo-tagged zone 603, at which the WLAN device of the vehicle 601 may switch to from a channel within the first bandwidth to a channel within the second bandwidth. The WLAN device on the vehicle 601 may prepare to switch to the channel within the second bandwidth before it encounters interference from the DSRC system 602.

In one embodiment, if the path of the vehicle is already selected, e.g., using an onboard navigation system, the vehicle may consult the database to predict possible geo-tagged zones of interference from DSRC systems 602 along the path. The WLAN device on the vehicle may plan to switch to a channel within the second bandwidth that is free of interference from the DSRC systems 602. Advantageously, the WLAN device may avoid the interruptions to the WLAN operation by switching channels within different bandwidths. In one embodiment, the WLAN device may pre-fetch or download the centralized database for offline use.

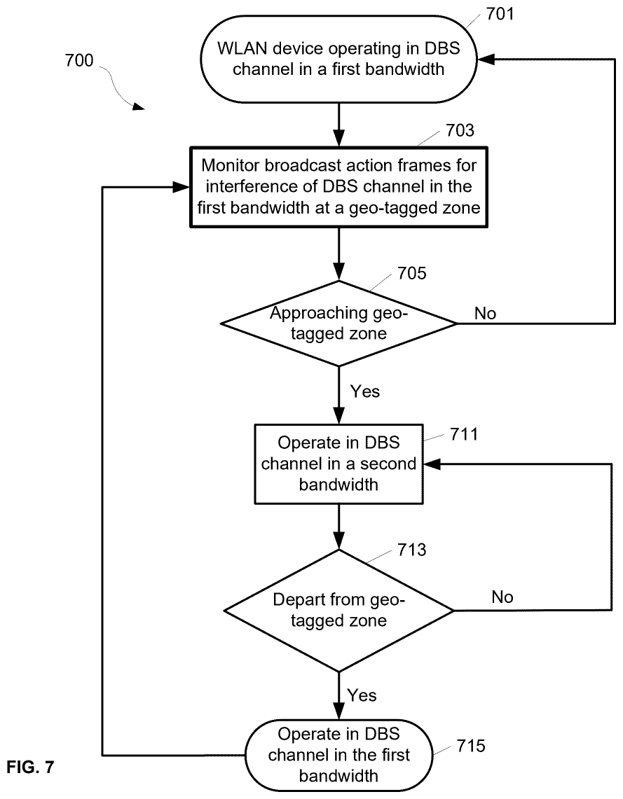

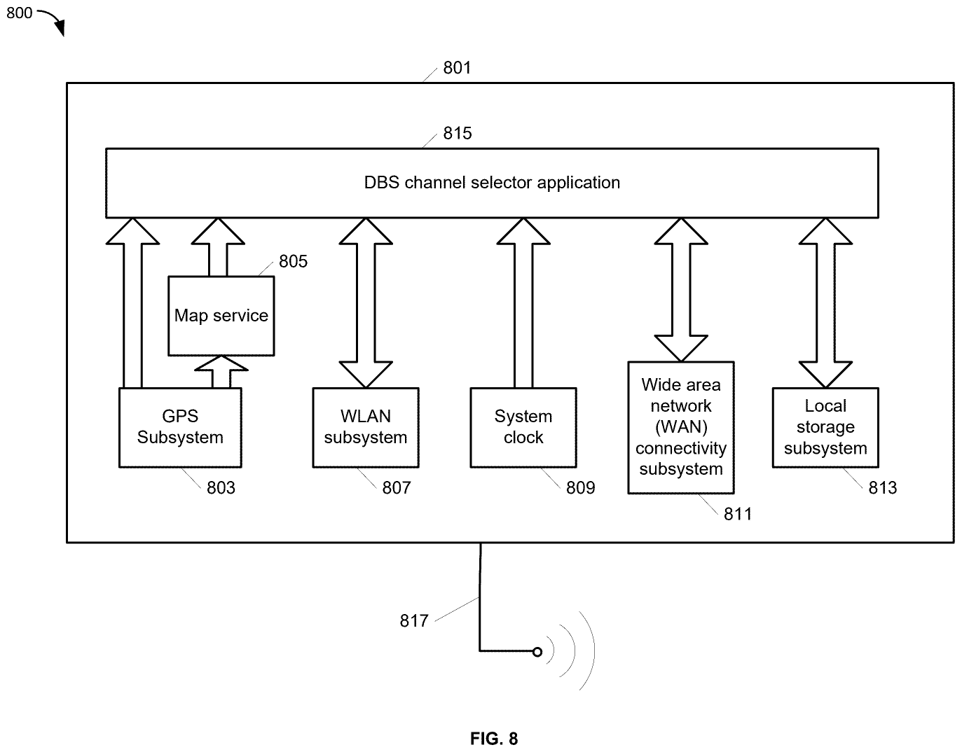

FIG. 7 illustrates a flow diagram of a method 700 for a WLAN device deployed in an automobile to change operational bandwidths of the WLAN device based on known interference locations, in accordance with some embodiments of the present disclosure. Method 700 may be performed by processing logic that may comprise hardware (e.g., circuitry, dedicated logic, programmable logic, a processing device, a central processing unit (CPU), a multi-core processor, a system-on-chip (SoC), etc.), software (e.g., instructions running/executing on a processing device), firmware (e.g., microcode), or a combination thereof. In some embodiments, the method 700 may be performed by a WLAN DBS device, or a processing device included in a WLAN device (e.g., processing device 801 illustrated in FIG. 8).

At 701, a WLAN device may operate in a DBS channel that is within a first bandwidth. For example, a WLAN DBS device in a vehicle may operate in a first DBS channel that is within the first bandwidth that is available for WLAN operation. In some embodiments, the first bandwidth may comprise an 80 MHz bandwidth.

In some aspects, for example at 703, the WLAN device may monitor for broadcast signals indicating the presence of interference of the first channel within the first bandwidth. For example, the WLAN device may receive a broadcast WLAN action frame comprising information that the first channel will be overlapped at a geo-tagged zone. The WLAN action frame may be utilized to initiate a dynamic bandwidth switch that leads to a bandwidth switch for the WLAN device.

At 705, the WLAN device may determine if the WLAN device is approaching the geo-tagged zone. The geo-tagged zone may comprise a geographical area that includes a DSRC system whose transmissions cause interference to the WLAN device, as discussed in connection with geo-tagged zone 603 and DSRC system 602 of FIG. 6. If the WLAN device determines that the vehicle is not approaching the geo-tagged zone (e.g., No branch), then the WLAN device may continue operating on a channel within the first bandwidth. The WLAN device to determine that the WLAN device is approaching the geo-tagged zone may receive an indication that the geographical position of the WLAN device is approaching the geo-tagged zone. The location of the geo-tagged zone may be a known location that is stored on a database stored locally within the WLAN device, a vehicle comprising the WLAN device, or may be stored on a network server that is accessible by the WLAN device and/or the vehicle. For example, the WLAN device and/or the vehicle may determine the positioning based on the GPS coordinates of the WLAN device or of the vehicle. If the WLAN device determines that the WLAN device is approaching the geo-tagged zone (e.g., Yes branch), then at 711, the WLAN device may operate in a channel that is within a second bandwidth. For example, the WLAN device may change the operation of the WLAN device from the DBS channel in the first bandwidth to a DBS channel in a second bandwidth. The switch from the first bandwidth to the second bandwidth may occur in response to a determination that the WLAN device is approaching the geo-tagged zone. In some aspects, the DBS channel in the second bandwidth is selected from one or one or more alternate DBS channels within the second bandwidth. In some aspects, the second bandwidth is less than the first bandwidth. For example, the first bandwidth may comprise 80 MHz, while the second bandwidth may comprise 40 MHz. However, in other aspects, the first bandwidth may comprise a bandwidth that is greater or lesser than 80 MHz, and the second bandwidth may comprise a bandwidth that is greater or lesser than 40 MHz.

At 713, the WLAN device may determine if the WLAN device has departed from the geo-tagged zone. If the WLAN device determines that the WLAN device has not departed from the geo-tagged zone (e.g., No branch), then the WLAN device may continue operating on a channel within the second bandwidth. The WLAN device may determine that the WLAN device has not departed from the geo-tagged zone based on the GPS coordinates of the WLAN device and/or the vehicle. If the WLAN device determines that the WLAN device has departed from the geo-tagged zone (e.g., Yes branch), then at 715, the WLAN device may operate in a channel in the first bandwidth. For example, the WLAN device may switch the operation of the WLAN device form the channel in the second bandwidth to a channel in the first bandwidth. The switch from the second bandwidth to the first bandwidth may occur in response to a determination that the WLAN device has departed or is departing from the geo-tagged zone. The WLAN device may switch back to the first bandwidth due, in part, to the physical separation between the WLAN device and the DSRC system within the geo-tagged zone. The WLAN device being outside or beyond the geo-tagged zone provide a physical separation between the WLAN device and the DSRC system such that transmission from the DSRC system do not cause interference to the WLAN device after the switch back to a channel within the first bandwidth.

FIG. 8 is a block diagram of a WLAN DFS device 801 deployed in a vehicle configured to change operational bandwidth of the WLAN device based on known interference locations, in accordance with some embodiments of the present disclosure. The WLAN DFS device 801 may be the WLAN device on the vehicle 601, and may practice the steps of method 700.

The WLAN DFS device 801 may include a GPS subsystem 803, a map service 805, a WLAN subsystem 807, system clock 809, a wide area network (WAN) connectivity subsystem 811, a local storage subsystem 813, and a DBS bandwidth selector application 815.

The GPS subsystem 803 may be configured to provide the GPS coordinates of the WLAN DFS device 801. The GPS coordinates may be used to identify that the vehicle is approaching a geo-tagged zone. The map service 805 may be configured to map the GPS coordinates provided by the GPS subsystem 803 to a path of travel and may also provide navigation services for a vehicle. The path of travel may be used by a database of known geo-tagged zone to predict the possible interference from DSRC systems along the path.

The WLAN subsystem 807 may be configured to use a selected channel from a first or second bandwidth for WLAN operation. For example, the WLAN subsystem 807 may be configured to transmit or receive data packet, control frames, etc., with other WLAN devices or an AP over a WLAN channel. The system clock 809 may be configured to keep track of the system time. In one embodiment, the GPS subsystem 803 may be configured to provide the system time.

The WAN connectivity subsystem 811 may be configured to upload information on DSRC systems that interfere with the WLAN that are not included in the database including the channels of the detected interference, recorded GPS coordinates and recorded times at which the radar signals are detected to a network server (e.g., 604). The WAN connectivity subsystem 811 may also be configured to transmit the current GPS coordinates of the WLAN DBS device 801 and to receive information on interference near the current GPS coordinates from the network server (e.g., 604).

The local storage subsystem 813 may be configured to store a local database of known geo-tagged zones. In one embodiment, the local storage subsystem 813 may contain a local knowledge base of geo-tagged zones that have been pre-configured. In one embodiment, the local storage subsystem 813 may store geo-tagged zones downloaded from the network server (e.g., 604).

The DBS channel selector application 815 may be run on a processor to perform one or more of the operations in the method 700 of FIG. 7 for the WLAN DFS device 801 to change operational bandwidths of the WLAN device based on known interference locations.

The WLAN DBS device 801 may further include an antenna 817 that may interface with the WLAN DBS device 801 to transmit or receive information.

In one embodiment, the WLAN DBS device 801 may include a memory and a processing device. The memory may be synchronous dynamic random access memory (DRAM), read-only memory (ROM)), or other types of memory, which may be configured to store the DBS channel selector application 815 or the local storage subsystem 813. The processing device may be provided by one or more general-purpose processing devices such as a microprocessor, central processing unit, or the like. In an illustrative example, processing device may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device may also comprise one or more special-purpose processing devices such as an application specific integrated circuit (ASIC), a field programmable gate array (FPGA), a digital signal processor (DSP), network processor, or the like. The processing device may be configured to execute the operations described herein, in accordance with one or more aspects of the present disclosure, for performing the operations and steps discussed herein.

Unless specifically stated otherwise, terms such as “receiving,” “generating,” “verifying,” “performing,” “correcting,” “identifying,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

Certain embodiments may be implemented as a computer program product that may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions. The machine-readable medium may be referred to as a non-transitory machine-readable medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Also, the terms “first,” “second,” “third,” “fourth,” etc., as used herein are meant as labels to distinguish among different elements and may not necessarily have an ordinal meaning according to their numerical designation. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method of operating a wireless local area network (WLAN) device, comprising:
operating the WLAN device on a first dynamic bandwidth selection (DBS) channel of a plurality of DBS channels within a first bandwidth;
determining, by the WLAN device, that the WLAN device is approaching a geo-tagged zone, wherein the geo-tagged zone interferes with operation of the WLAN device; and
changing the operation of the WLAN device from the first DBS channel of the first bandwidth to a second DBS channel within a second bandwidth in response to the determining that the WLAN device is approaching the geo-tagged zone.

2. The method of claim 1, wherein the determining that the WLAN device is approaching the geo-tagged zone further comprises:
receiving, by the WLAN device, an indication that a geographical position of the WLAN device is approaching the geo-tagged zone, wherein a location of the geo-tagged zone is known and interferes with the operation of the WLAN device.

3. The method of claim 2, wherein the location of the geo-tagged zone is stored on a database, wherein the database is external to the WLAN device, wherein the database contains a plurality of geo-tagged zones that interfere with the operation of the WLAN device.

4. The method of claim 1, further comprising:
determining, by the WLAN device, that the WLAN device has departed from the geo-tagged zone.

5. The method of claim 4, wherein the determining that the WLAN device has departed from the geo-tagged zone further comprises:
receiving, by the WLAN device, a departure indication that a geographical position of the WLAN device is beyond the geo-tagged zone.

6. The method of claim 5, further comprising:
changing the operation of the WLAN device from the second DBS channel of the second bandwidth to one of the plurality of DBS channels within the first bandwidth in response to a determination that the WLAN device has departed from the geo-tagged zone.

7. The method of claim 1, further comprising:
receiving, by the WLAN device, a broadcast WLAN action frame comprising information that the first DBS channel is overlapped at the geo-tagged zone.

8. The method of claim 7, wherein the second DBS channel is selected from one of one or more alternate DBS channels within the second bandwidth.

9. A wireless local area network (WLAN) device, comprising:
a WLAN interface configured to operate the WLAN device on a first dynamic bandwidth selection (DBS) channel of a plurality of DBS channels within a first bandwidth; and
a processing device configured to:
determine, by the WLAN device, that the WLAN device is approaching a geo-tagged zone, wherein the geo-tagged zone interferes with operation of the WLAN device; and
switch the first DBS channel of the first bandwidth to a second DBS channel within a second bandwidth in response to the determining that the WLAN device is approaching the geo-tagged zone.

10. The WLAN device of claim 9, wherein to determine that the WLAN device is approaching the geo-tagged zone the processing device is further configured to:
receive an indication that a geographical position of the WLAN device is approaching the geo-tagged zone, wherein a location of the geo-tagged zone is known and interferes with the operation of the WLAN device.

11. The WLAN device of claim 10, wherein the location of the geo-tagged zone is stored on a database, wherein the database is external to the WLAN device, wherein the database contains a plurality of geo-tagged zones that interfere with the operation of the WLAN device.

12. The WLAN device of claim 9, wherein the processing device is further configured to:
determine that the WLAN device has departed from the geo-tagged zone.

13. The WLAN device of claim 12, wherein to determine that the WLAN device has departed from the geo-tagged zone the processing device is further configured to:
receive a departure indication that a geographical position of the WLAN device is beyond the geo-tagged zone.

14. The WLAN device of claim 13, wherein the processing device is further configured to:
switch the second DBS channel within the second bandwidth to one of the plurality of DBS channels within the first bandwidth in response to a determination that the WLAN device has departed from the geo-tagged zone.

15. The WLAN device of claim 9, wherein the processing device is further configured to:
receive a broadcast WLAN action frame comprising information that the first DBS channel is overlapped at the geo-tagged zone.

16. The WLAN device of claim 15, wherein the second DBS channel is selected from one of one or more alternate DBS channels within the second bandwidth.

17. A system, comprising:
an antenna unit comprising an antenna feed and a plurality of parasitic elements, wherein the antenna unit is configured to receive a plurality of signals; and
a communication device comprising a communication port coupled to the antenna feed and a communication bus coupled to the plurality of parasitic elements, wherein the communication device is configured to:
operate, by the communication device, on a first dynamic bandwidth selection (DBS) channel of a plurality of DBS channels within a first bandwidth;
determine, by the communication device, that the communication device is approaching a geo-tagged zone, wherein the geo-tagged zone interferes with operation of the communication device; and
change the operation of the communication device from the first DBS channel of the first bandwidth to a second DBS channel within a second bandwidth in response to a determination that the communication device is approaching the geo-tagged zone.

18. The system of claim 17, wherein to determine that the communication device is approaching the geo-tagged zone the communication device is further configured to:
receive an indication that a geographical position of the communication device is approaching the geo-tagged zone, wherein a location of the geo-tagged zone is known and interferes with the operation of the communication device.

19. The system of claim 18, wherein the location of the geo-tagged zone is stored on a database, wherein the database is external to the communication device, wherein the database contains a plurality of geo-tagged zones that interfere with the operation of the communication device.

20. The system of claim 17, wherein the communication device is further configured to:
determine that the communication device has departed from the geo-tagged zone.
